(19) United States
(12) Patent Application Publication
(10) Pub. No.: US 2006/0041364 A1
(43) Pub. Date: Feb. 23, 2006

(54) Vehicle behavior control device

(75) Inventors: Yuichiro Tsukasaki, Tokyo (JP); Masaru Kogure, Tokyo (JP)

Correspondence Address: HAYNES AND BOONE, LLP, 901 MAIN STREET, SUITE 3100, DALLAS, TX, 75202, US

(73) Assignee: Fuji Jukogyo Kabushiki Kaisha, Tokyo (JP)

(21) Appl. No.: 11/196,769

(22) Filed: Aug. 3, 2005

(30) Foreign Application Priority Data
Aug. 4, 2004 (JP) 2004-228429

(51) Int. Cl. G06F 17/00

(52) U.S. Cl. 701/69

(57) ABSTRACT

The objective of the present invention is to provide a vehicle behavior control device, wherein vehicle behaviors are quickly detected by use of a small number of sensors for achieving stability without sacrificing speed while giving a driver natural, smooth steering. According to the present invention, the vehicle behavior control device includes: a force detecting unit for detecting a tire force acting on each wheel of a vehicle; a yaw moment computing unit for computing a yaw moment of the vehicle based on the tire force acting on each wheel detected by the force detecting unit, the yaw moment being generated by a driving force transmitted to each wheel; a cornering power computing unit for computing a cornering power of each wheel based on the tire force acting on each wheel detected by the force detection unit; and a correcting unit for correcting the yaw moment based on a moment of inertia of the vehicle and the cornering powers.

### CROSS REFERENCE TO RELATED APPLICATIONS

This application claims priority under 35 U.S.C. 119 based upon Japanese Patent Application Serial No. 2004-228429, filed on Aug. 4, 2004. The entire disclosure of the aforesaid application is incorporated herein by reference.

### BACKGROUND OF THE INVENTION

1. Field of the Invention

The present invention relates to a vehicle behavior control device, which properly controls the force applied to its wheels for achieving stability without sacrificing speed.

2. Description of the Related Art

In recent years, a wide variety of vehicle behavior control devices have been developed for the purpose of improving driving stability. In these devices, provision is made for properly distributing a driving force or a braking force to the front, rear, right, and left directions.

For example, Japan Ko-kai Publication No. 2002-120711 disclosed a technology for providing a driver with smooth, natural steering by taking up his steering operations as intended as possible. In this technology, a first target yaw rate based on a road surface shape and a second target yaw rate based on driving conditions are obtained; the braking force is controlled based on the two target yaw rates; and the driving force is properly distributed to the right and left rear wheels while cornering. Driving stability is thus improved. The entire disclosure of the aforesaid Japan Ko-kai Publication No. 2002-120711 is incorporated herein by reference.

The technology disclosed in the above reference involves a control method wherein the target yaw rates are estimated by sensors, or target yaw moments are estimated, to control the braking/driving force distribution to the right and left rear wheels based on the estimated parameters. In this case, however, yaw moments are generated during acceleration due to the difference between the right and left braking/driving forces respectively distributed, thereby giving rise to awkward feelings to the driver. In addition, since the control is performed based on the estimated parameters, the control response is not good because of control delays and sensor errors. Furthermore, yaw moments caused by steering operations are often so generated as a driver wishes; thus, ironically, canceling such yaw moments may give the driver unnatural, awkward feelings.

### SUMMARY OF THE INVENTION

In view of the above circumstances, the objective of the present invention is to provide a vehicle behavior control device, wherein vehicle behaviors are quickly detected by use of a small number of sensors for achieving stability without sacrificing speed while giving a driver natural, smooth steering.

According to the present invention, there is provided a behavior control device comprising: a force detecting unit for detecting a tire force acting on each wheel of a vehicle; a yaw moment computing unit for computing a yaw moment of the vehicle based on the tire force acting on each wheel detected by the force detecting unit, the yaw moment being generated by a driving force transmitted to each wheel; a cornering power computing unit for computing a cornering power of each wheel based on the tire force acting on each wheel detected by the force detection unit; and a correcting unit for correcting the yaw moment based on a moment of inertia of the vehicle and the cornering powers.

According to the vehicle behavior control device of the present invention, it is possible to quickly detect vehicle behaviors with a small number of sensors and achieve stability without sacrificing speed while giving a driver natural, smooth feelings.

According to one embodiment of the present invention, it is preferable that the vehicle behavior control device further comprises a driving force distribution control unit for controlling a driving force distribution, wherein the yaw moment is generated by the driving force transmitted to each wheel is a yaw moment resulting from an action of the driving force distribution control unit. In this case, it is desirable that the driving force distribution control unit controls the driving force distribution between a right and left wheels.

According to one other embodiment of the present invention, it is preferable that the vehicle behavior control device further comprises a steering angle correcting unit for correcting a steering angle, wherein the correcting unit converts the corrected yaw moment to a steering angle or a steering gear ratio, which is then outputted to the steering angle correcting unit.

According to one further embodiment of the present invention, the vehicle behavior control device further comprises a yaw rate deviation computing unit for computing a target yaw rate based on driving conditions and obtaining a yaw rate deviation which is a difference between the target yaw rate and an actual yaw rate, wherein the correcting unit corrects the yaw moment generated by the driving force to each wheel, based on the moment of inertia of the vehicle, the cornering powers, and the yaw rate deviation.

Those skilled in the art will appreciate these and other advantages and benefits of various embodiments of the invention upon reading the following detailed description of the preferred embodiments with reference to the below-listed drawings.

### BRIEF DESCRIPTION OF THE DRAWINGS

FIG. 1 is a schematic diagram showing a vehicle structure provided with a vehicle behavior control device according to a first embodiment of the present invention;

FIG. 2 is a schematic diagram showing a right and left driving force distribution control device according to the first embodiment;

FIG. 3 is a schematic functional block diagram of a yaw moment correction device and the vehicle behavior control device according to the first embodiment;

FIG. 4 is a graph showing an example of the relationship between a right and left driving force distribution ratio and a lateral acceleration;

FIG. 5 is an explanatory diagram showing a two-wheel model equivalent to a four-wheel model;

FIG. 6 is an explanatory graph showing cornering powers;

FIG. 7 is a schematic diagram showing a vehicle structure provided with a vehicle behavior control device according to a second embodiment of the present invention;

FIG. 8 is a schematic functional block diagram of a yaw moment correction device and the vehicle behavior control device according to the second embodiment;

FIG. 9 is a schematic diagram showing a vehicle structure provided with a vehicle behavior control device according to a third embodiment of the present invention;

FIG. 10 is a schematic functional block diagram of a yaw moment correction device and the vehicle behavior control device according to the third embodiment;

FIG. 11 is a schematic diagram showing a vehicle structure provided with a vehicle behavior control device according to a fourth embodiment of the present invention; and

FIG. 12 is a schematic functional block diagram of a yaw moment correction device and the vehicle behavior control device according to the fourth embodiment.

### DETAILED DESCRIPTION OF THE PREFERRED EMBODIMENTS

Embodiments of the present invention are described below with reference to the accompanying drawings to facilitate understanding of the present invention.

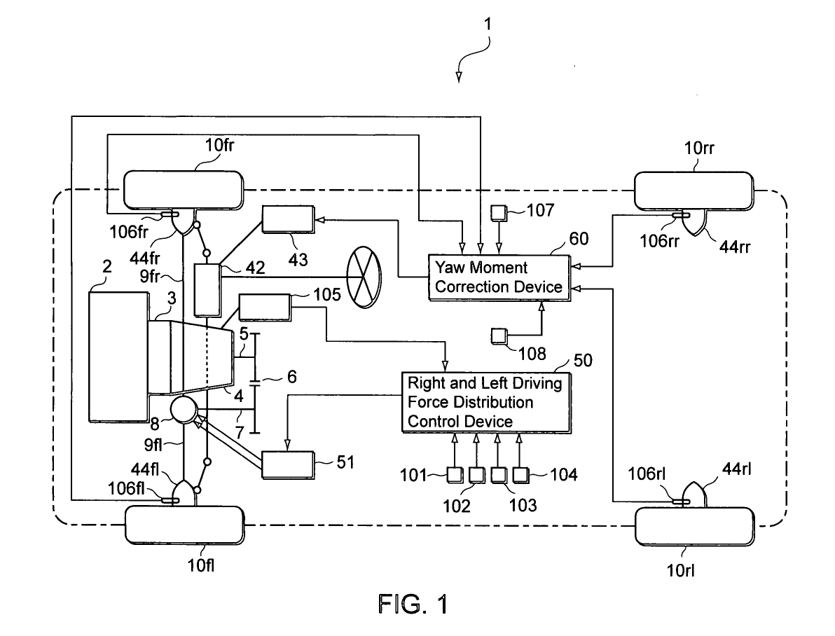

In FIG. 1, the reference numeral 1 refers to a vehicle such as an automobile. In a first embodiment according to the present invention, the vehicle 1 is a FF (Front engine—Front-wheel drive) car, in which a driving force generated by an engine 2 is transmitted through a torque converter 3 and a transmission device 4 to a transmission output axle 5. The driving force transmitted to the transmission output axle 5 is further transmitted through a reduction gear array 6 to a front drive axle 7, and inputted to a front wheels final velocity reduction device 8.

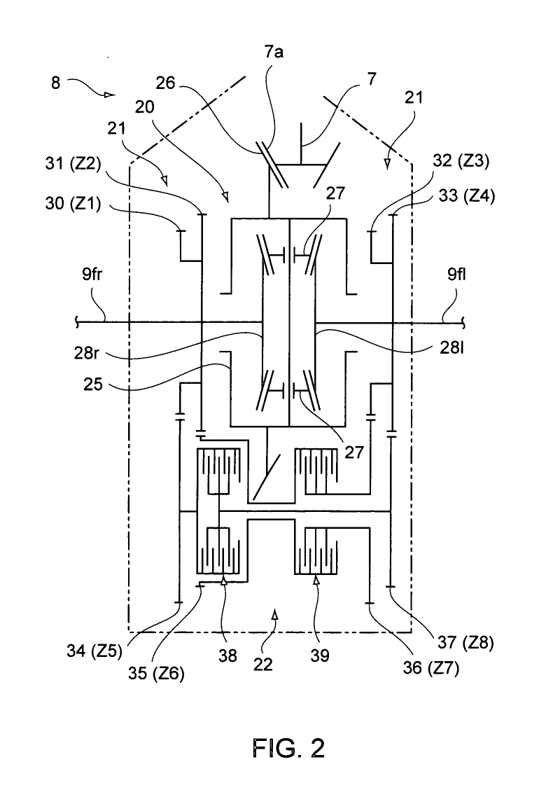

The driving force inputted to the front wheels final velocity reduction device 8 is further transmitted through a front wheel left axle 9fl to a front left wheel 10fl as well as through a front wheel right axle 9fr to a front right wheel 10fr. Since a FF car is of interest in this first embodiment, the driving force is not transmitted to a rear left wheel 10rl or a rear right wheel 10rr. As described later, the front wheels final velocity reduction device 8 has a variable control depending on driving force distribution ratios obtained at a right and left driving force distribution control device 50 as a control unit for distributing the driving force. Specifically, as shown in FIG. 2, the front wheels final velocity reduction device 8 mainly comprises a differential system 20, a gear system 21, and a clutch system 22.

The differential system 20 may comprise, for example, a differential device with bevel gears and a differential case 25 which is provided peripherally with a final gear 26 engaged with a drive pinion 7a for the front drive axle 7.

Further, in the differential case 25, a pair of differential pinions 27 are rotatably held around an axis; right and left side gears 28r and 28l are engaged with the differential pinions 27; and the front wheel right and left axles 9fr and 9fl are connected to the right and left side gears 28r and 28l, respectively.

The gear system 21 comprises first and second gears 30 and 31 fixed to the front wheel right axle 9fr, third and fourth gears 32 and 33 fixed to the front wheel left axle 9fl, and fifth through eighth gears 34-37 engaged with the gears 30-33 respectively. In the present first embodiment, the second gear 31 has a larger diameter than the first gear 30, and the number of teeth Z2 of the second gear 31 is greater than that Z1 of the first gear 30. The third gear 32 has the same diameter and the same number of teeth as the first gear 30 (Z3=Z1), and the fourth gear 33 has the same diameter and the same number of teeth as the second gear 31 (Z4=Z2). The fifth through eighth gears 34-37 are rotatably held around an axis which is parallel to the axles 9fl and 9fr. The first and fifth gears 30 and 34 comprise a first gear array by engaging with each other. The number of teeth of the fifth gear 34 is predetermined by setting the gear ratio of the first gear array (Z5/Z1) to, for example, 1.0. The second and sixth gears 31 and 35 comprise a second gear array by engaging with each other. The number of teeth of the sixth gear 35 is predetermined by setting the gear ratio of the second gear array (Z6/Z2) to, for example, 0.9. The third and seventh gears 32 and 36 comprise a third gear array by engaging with each other. The number of teeth of the seventh gear 36 is predetermined by setting the gear ratio of the third gear array (Z7/Z3) to, for example, 1.0. The fourth and eighth gears 33 and 37 comprise a fourth gear array by engaging with each other. The number of teeth of the eighth gear 37 is predetermined by setting the gear ratio of the fourth gear array (Z8/Z4) to, for example, 0.9.

The clutch system 22 comprises a first hydraulic multi-board clutch 38, which connects and disconnects the fifth gear 34 and the eighth gear 37, and a second hydraulic multi-board clutch 39, which connects and disconnects the sixth gear 35 and the seventh gear 36. A hydraulic chamber (not shown in the figure) for each of the hydraulic multi-board clutches 38 and 39 is connected to a hydraulic operation section 51 (FIG. 1). The first or second hydraulic multi-board clutch 38 or 39 is engaged depending on the hydraulic pressure supplied from the hydraulic operation section 51. More driving force is applied to the front wheel left axle 9fl when the first hydraulic multi-board clutch 38 is engaged, and more driving force is applied to the front wheel right axle 9fr when the second hydraulic multi-board clutch 39 is engaged. Here, the hydraulic pressure value for engaging each of the hydraulic multi-board clutches 38 and 39 is computed by the hydraulic operation section 51 based on the driving force distribution ratio between the front left wheel 10fl and the front right wheel 10fr, which is set by the right and left driving force distribution control device 50. Specifically, a torque distribution amount is varied depending on the hydraulic pressure value. Incidentally, the structure of the final velocity reduction device 8 is not limited to the one according to this first embodiment; other structures, for example, those described in detail in Japan Ko-kai Publication No. Hei 11-263140, may be employed. The entire disclosure of the aforesaid Japan Ko-kai Publication No. Hei 11-263140 is incorporated herein by reference.

In FIG. 1, the reference numeral 42 refers to a conventional vehicle steering device as a steering angle correction unit, for example, of a velocity sensing type, comprising a motor, a gear system, and a hydraulic chamber, whereby a steering gear ratio is variable. The steering gear ratio in the vehicle steering device 42 is inputted from a steering gear ratio variable control section 43. The steering gear ratio in the steering gear ratio variable control section 43 is inputted after being corrected by a yaw moment correction device 60, which is described later.

In the following, the right and left driving force distribution control device 50 and the yaw moment correction device 60 are explained.

The right and left driving force distribution control device 50 is connected to a lateral acceleration sensor 101, a turbine rotation number sensor 102, an engine rotation number sensor 103, a throttle open angle sensor 104, and a transmission control device 105. Inputs from these parts to the right and left driving force distribution control device 50 are a lateral acceleration (d²y/dt²), a turbine rotation number Nt, an engine rotation number Ne, a throttle open angle θth, and a transmission gear ratio rg, respectively.

The yaw moment correction device 60 is connected to force detection sensors 106fl, 106fr, 106rl, and 106rr which are embedded respectively in axle housings 44fl, 44fr, 44rl, and 44rr for the four wheels 10fl, 10fr, 10rl, and 10rr. The force detection sensors 106fl, 106fr, 106rl, and 106rr are provided as a force detection unit for detecting each of the tire forces along the longitudinal direction (x direction), lateral direction (y direction), and vertical direction (Z direction) acting on respective wheels, based on difference amounts generated in the axle housings 44fl, 44fr, 44rl, and 44rr. For example, the sensors disclosed in Japan Ko-kai Publication No. Hei 9-2240 may be employed for the force detection sensors 106fl, 106fr, 106rl, and 106rr. The entire disclosure of the aforesaid Japan Ko-kai Publication No. Hei 9-2240 is incorporated herein by reference. The inputs from the force detection sensors 106fl and 106fr to the yaw moment correction device 60 are tire forces along the longitudinal, lateral, and vertical directions applied to the front left and front right wheels, respectively, i.e. Fflx, Ffly, Fflz, Ffrx, Ffry, and Ffrz; and the inputs from the force detection sensors 106rl and 106rr to the yaw moment correction device 60 are tire forces along the longitudinal direction applied to the rear left and rear right wheels, respectively, i.e. Frlx and Frrx.

The yaw moment correction device 60 is further connected to a steering angle sensor 107 and a road surface friction coefficient estimation device 108, which input to the yaw moment correction device 60 a steering angle θH and a road surface friction coefficient estimated value μ, respectively. In the road surface friction coefficient estimation device 108, the road surface friction coefficient estimated value μ is evaluated through an estimation method such as the one proposed by the Applicant in Japan Ko-kai Publication No. Hei 8-2274. The entire disclosure of the aforesaid Japan Ko-kai Publication No. Hei 8-2274 is incorporated herein by reference. In this estimation method, a cornering power of the wheels is estimated by extrapolating to the nonlinear region the equation of lateral motion described with the steering angle, velocity, and actual yaw rate of a vehicle; and the road surface friction coefficient value μ is estimated by using a ratio between the estimated cornering power and a cornering power equivalent to the case of μ=1.0 (high μ road) for each of the front and rear wheels. Incidentally, the estimation method is not limited to the above approach. The method disclosed by the Applicant in Japan Ko-kai Publication No. 2000-71968, for example, may be employed. The entire disclosure of the aforesaid Japan Ko-kai Publication No. 2000-71968 is incorporated herein by reference. It is also possible to obtain the road surface friction coefficient estimated value μ based on a sliding rate of each wheel.

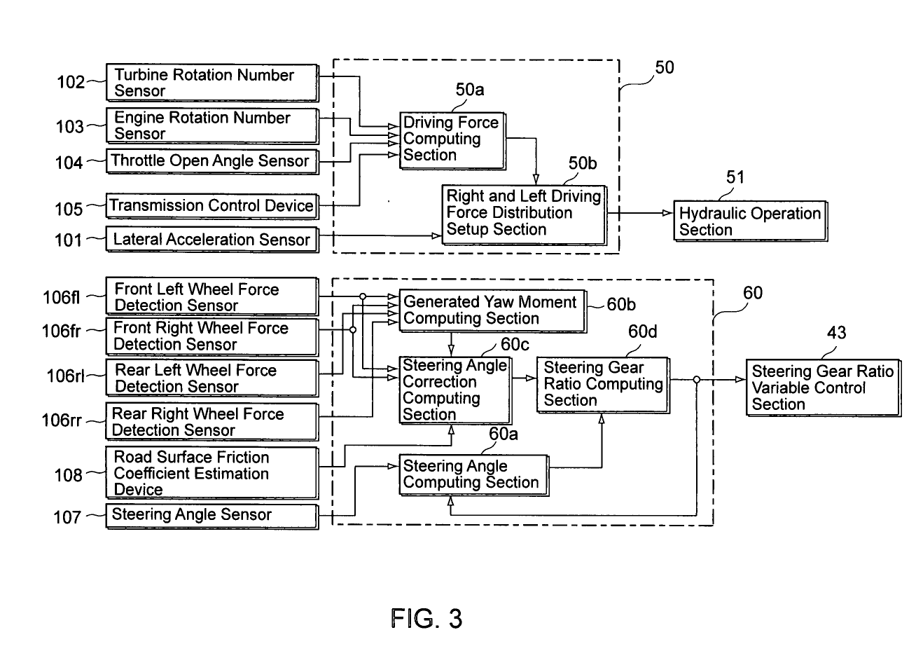

As shown in FIG. 3, the right and left driving force distribution control device 50 mainly comprises a driving force computing section 50a and a right and left driving force distribution setup section 50b.

Inputs to the driving force computing section 50a from the turbine rotation number sensor 102, the engine rotation number sensor 103, the throttle open angle sensor 104, and the transmission control device 105 are the turbine rotation number Nt, the engine rotation number Ne, the throttle open angle θth, and the transmission gear ratio rg, respectively. By using the above inputs and transmission characteristics, an engine driving force Fe is obtained as in Eq. (1):
Fe=(Tt·rf)/RW, (1)
where rf is a final gear ratio, RW is an effective radius of a tire, and Tt is a torque after a transmission gear is applied. The result is then outputted to the right and left driving force distribution setup section 50b. By using a toque converter ratio tconv and a dynamical transmission efficiency η, Tt is expressed as in Eq. (2):
Tt=Te·rg·tconv·η, (2)
where an engine torque Te is obtained from a map based on the engine rotation number Ne and the throttle open angle θth; and the torque converter ratio tconv is obtained from a map based on a velocity ratio of the torque converter, rv (=Nt/Ne).

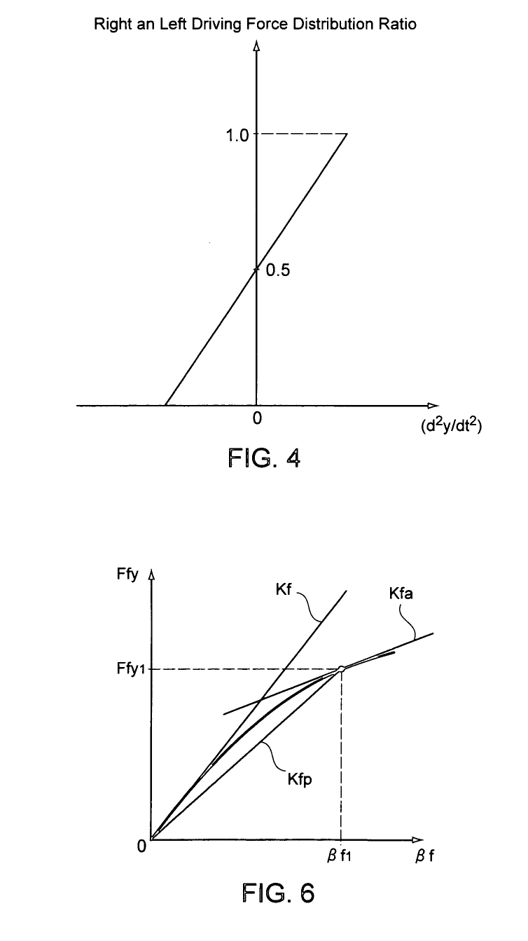

Other inputs to the right and left driving force distribution setup section 50b are the lateral acceleration (d²y/dt²) from the lateral acceleration sensor 101 and the engine driving force Fe from the driving force computing section 50a. For example, the distribution ratio between the right and left driving forces at a lateral acceleration (d²y/dt²) value may be obtained from a predetermined map such as the one in FIG. 4. Then, a signal is emitted to the hydraulic operation section 51 for distributing the engine driving force Fe based on the above distribution ratio between the right and left driving forces.

The yaw moment correction section 60 mainly comprises a steering angle computing section 60a, a generated yaw moment computing section 60b, a steering angle correction computing section 60c, and a steering gear ratio computing section 60d.

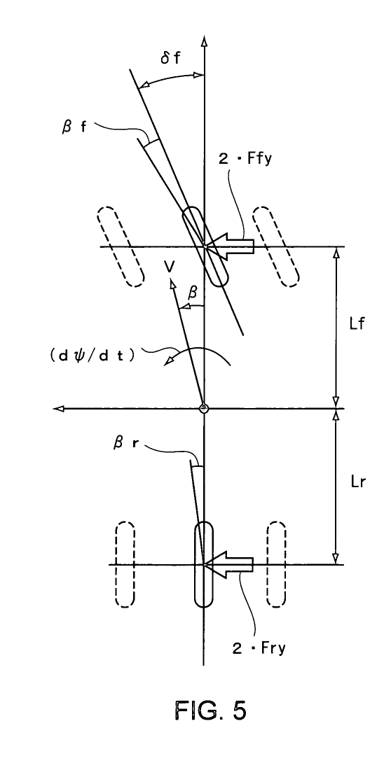

First, in order to describe the yaw moment correction section 60, details of the necessary equations are given below with reference to FIG. 5.

The equation of motion with regard to the lateral translational motion of a vehicle is given by:
m·(d²y/dt²)=2·Ffy+2·Fry, (3)
where Ffy and Fry are cornering forces per wheel for the front and rear wheels, respectively, and m is a vehicle mass.

The equation of motion with regard to the rotational motion around the center of gravity is given by:
Iz·(dφ²/dt²)=2·Ffy·Lf−2·Fry·Lr, (4)
where Lf and Lr are distances from the center of gravity to the front and rear wheel axles, respectively, Iz is a moment of inertia of the vehicle, and dφ²/dt² is a yaw angle acceleration.

The lateral acceleration d²y/dt² is expressed as:
d²y/dt²=V·(dβ/dt+dφ/dt), (5)
where β is a sliding angle of the vehicle, dβ/dt is a sliding angular velocity, dφ/dt is a yaw angular velocity (yaw rate), and V is a vehicle velocity.
By using the vehicle motion model described with the above equations (3)-(5) and canceling the yaw moment M, which is generated by the right and left driving force distribution, by a front wheel steering angle correction Δδf, the equation of state is obtained as follows:

$$\frac{ⅆ x ( t )}{ⅆ t} = A \cdot x ( t ) + B \cdot u ( t ) + n ( t ) , where \\ x ( t ) = {[ β ( \frac{ⅆ φ}{ⅆ t} ) ]}^{T} \\ u ( t ) = {[ ( δ f + Δδ f ) 0 ]}^{T} \\ n ( t ) = {[ 0 ( M / Iz ) ]}^{T} \\ A = [ \begin{matrix}a11 & a12 \\ a21 & a22\end{matrix} ] \\ B = [ \begin{matrix}b11 & b12 \\ b21 & b22\end{matrix} ] \\ a11 = 2 \cdot ( Kfa + Kra ) / ( M \cdot V ) \\ a12 = 1 + 2 \cdot ( Lf \cdot Kfa - Lr \cdot Kra ) / ( M \cdot {V}^{2} ) \\ a21 = 2 \cdot ( Lf \cdot Kfa - Lr \cdot Kra ) / Iz \\ a22 = 2 \cdot ( {Lf}^{2} \cdot Kfa - {Lr}^{2} \cdot Kra ) / ( Iz \cdot V ) \\ b11 = 2 \cdot Kfa / ( M \cdot V ) \\ b21 = 2 \cdot Lf \cdot Kfa / Iz \\ b12 = b22 = 0. \qquad ( 6 )$$

FIG. 6 shows a relationship between a front wheel sliding angle βf and a front wheel cornering force Ffy. By using the relationship, an actual cornering power Kfa at the front wheel sliding angle βf1 can be approximated as follows:
Kfa≈Kf−(Kf·|Ffly|)/(4·(μfl²·Fflz²−Fflx²)^{1/2})−(Kf·|Ffry|)/(4·(μfr²·Ffrz²−Ffrx²)^{1/2}). (7)
Similarly, an actual cornering power Kra at the rear wheel sliding angle βr1 can be approximated as follows:
Kra≈Kr−(Kr·|Frly|)/(4·(μrl²·Frlz²−Frlx²⁾^{1/2})−(Kr·|Frry|)/(4·(μrr²·Frrz²−Frrx²)^{1/2}). (8)
In the above, Kf and Kr are the cornering powers equivalent to the case of μ=1.0 of the front and rear wheels, respectively.

The distinct notations of μfl, μfr, μrl, and μrr are used in the equations (7) and (8), enabling easy substitution of the road surface friction coefficient estimated value μ for each wheel. However, in the present first embodiment, these values are equal, i.e. μfl=μfr=μrl=μrr=μ. The steering angle computing section 60a receives the steering angle θH from the steering angle sensor 107 and the current steering gear ratio sr from the steering gear ratio computing section 60d. Using these inputs, the steering angle computing section 60a computes the front wheel steering angle δf as in Eq. (9):
δf=θH/sr, (9)
which is then outputted to the steering gear ratio computing section 60d.

The generated yaw moment computing section 60b receives the longitudinal forces Fflx, Ffrx, Frlx, and Frrx from the force detection sensors 106fl, 106fr, 106rl, and 106rr, respectively. By using these inputs, the yaw moment M generated by the right and left driving force distribution is obtained as in Eq. (10):
M=(Ffrx−Fflx)df/2+(Frrx−Frlx)dr/2, (10)
where df and dr are front and rear tread widths, respectively. The result is then outputted to the steering angle correction computing section 60c. Note here that the generated yaw moment computing section 60b is provided as a yaw moment computing unit in the present embodiment.

The steering angle correction computing section 60c receives the longitudinal, lateral, and vertical forces Fflx, Ffly, Fflz, Ffrx, Ffry, and Ffrz from the front wheel force detection sensors 106fl and 106fr, the road surface friction coefficient estimated value μ from the road surface friction coefficient estimation device 108, and the yaw moment M from the generated yaw moment computing section 60b. By using these inputs, the front wheel steering angle correction Δδf is obtained as in Eq. (11):
Δδf=−M/(Iz·b21), (11)
which is then outputted to the steering gear ratio computing section 60d. Note here that the steering angle correction computing section 60c is provided as a cornering power computing and correcting unit in the present embodiment.

The steering gear ratio computing section 60d receives the front wheel steering angle δf from the steering angle computing section 60a and the front wheel steering angle correction Δδf from the steering angle correction computing section 60c. A new steering gear ratio srNew is computed by use of the current steering gear ratio sr as in Eq. (12):
srNew=(δf/(δf+Δδf))·sr, (12)
which is then outputted to the steering gear ratio variable control section 43. Note here that the steering gear ratio computing section 60d is provided also as a correcting unit in the present embodiment.

Instead of Eq. (7) with the front wheel lateral forces Ffly and Ffry, the following equation (7′) with the front wheel sliding angle βf may be employed:
Kfa≈Kf−(Kf²·|βf|)/(4·(μfl²·Fflz²−Fflx²)^{1/2})−(Kf²·|βf|)/(4·(μfr²·Ffrz²−Ffrx²)^{1/2}). (7′)

As seen above, according to the first embodiment of the present invention, the steering angle is controlled based on the yaw moment M, which is generated by the difference between the right and left driving/braking forces as detected by the force detection sensors 106fl, 106fr, 106rl, and 106rr, thereby maintaining the constant yaw moment for a whole vehicle. In other words, yaw moments other than those desired by the driver are canceled with a good response, resulting in improvement in the driving stability. Due to such an added control, an effective use of tire grips is possible via the right and left driving/braking force distribution control, giving rise to reduction in the sliding angle as well as in the driver's awkward feelings, and ultimately leading to realization of stability without sacrificing speed.

Further, the sensors used in the present embodiment are only the force detection sensors 106fl, 106fr, 106rl, and 106rr; thus, sensor errors arising from the conventional parameter estimates are not likely to occur. Also, cost reduction is possible.

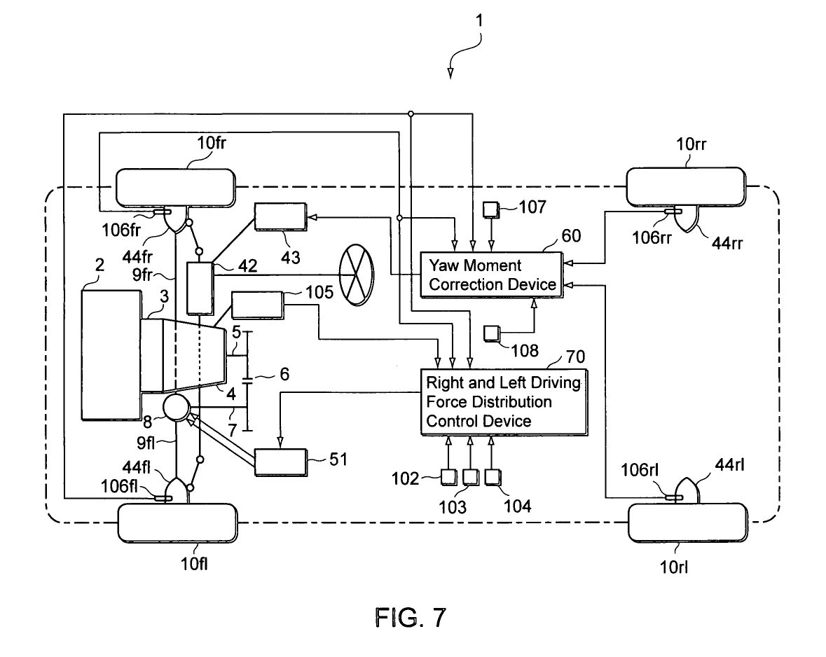

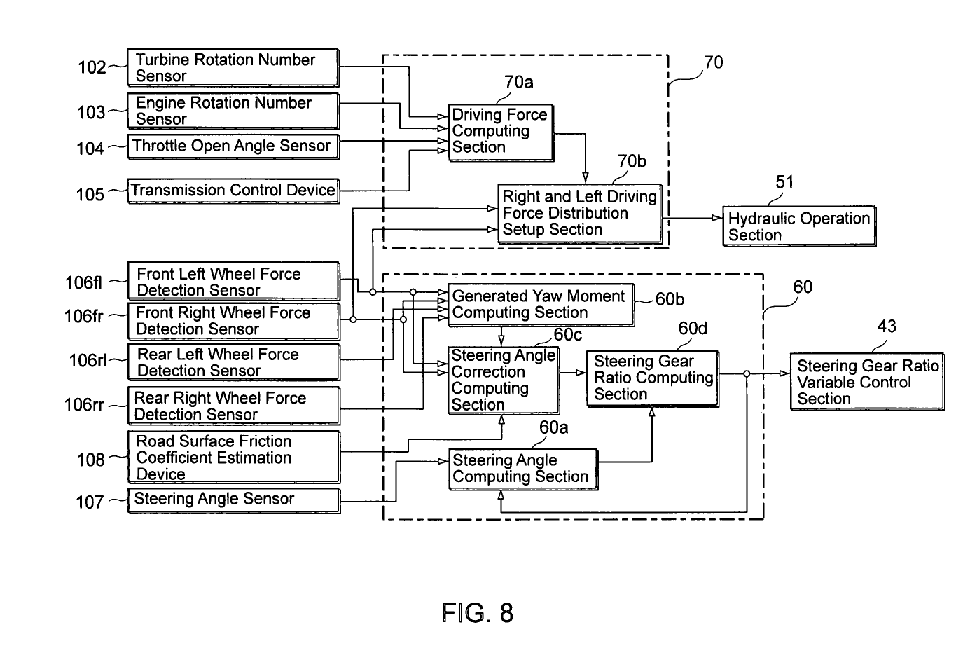

FIGS. 7 and 8 show a second embodiment according to the present invention. Specifically, FIG. 7 is a diagram showing a schematic structure of a vehicle provided with a vehicle behavior control device according to the second embodiment; and FIG. 8 is a functional block diagram of the yaw moment correction device and the vehicle behavior control device according to the second embodiment. The only difference between the first and second embodiments is the right and left driving force distribution control device as a vehicle driving force distribution control unit. Since the configuration of the other parts and their functional effects are the same between the two embodiments, the same reference numerals are used throughout for those parts, and the associated explanations are omitted below.

In FIGS. 7 and 8, the reference numeral 70 refers to the right and left driving force distribution control device, which is connected to the turbine rotation number sensor 102, the engine rotation number sensor 103, the throttle open angle sensor 104, and the transmission control device 105. Inputs from these parts to the right and left driving force distribution control device 70 are the turbine rotation number Nt, the engine rotation number Ne, the throttle open angle θth, and the transmission gear ratio rg, respectively. In addition, the right and left driving force distribution control device 70 is connected to the front wheel force detection sensors 106fl and 106fr. Inputs from these sensors to the right and left driving force distribution control device 70 are the vertical forces Fflz and Ffrz, respectively. As shown in FIG. 8, the right and left driving force distribution control device 70 mainly comprises a driving force computing section 70a and a right and left driving force distribution setup section 70b.

Similar to the driving force computing section 50a in the first embodiment, the driving force computing section 70a in the second embodiment receives the turbine rotation number Nt, the engine rotation number Ne, the throttle open angle θth, and the transmission gear ratio rg from the turbine rotation number sensor 102, the engine rotation number sensor 103, the throttle open angle sensor 104, and the transmission control device 105, respectively. By using the above inputs and transmission characteristics, the engine driving force Fe is obtained as in Eq. (1). The result is then outputted to the right and left driving force distribution setup section 70b. In addition, the right and left driving force distribution setup section 70b receives the vertical forces Fflz and Ffrz from the front wheel force detection sensors 106fl and 106fr. By using these inputs, the distribution ratio between the right and left driving forces is determined as in Eq. (13):
(Driving Force for the Front Left Wheel): (Driving Force for the Front Right Wheel)=(Fflz/(Fflz+Ffrz)):(Ffrz/(Fflz+Ffrz)). (13)
A signal is then emitted to the hydraulic operation section 51 for distributing the engine driving force Fe based on the above distribution ratio between the right and left driving forces.

As seen above, the same effect as that obtained in the first embodiment can be obtained by use of a different right and left driving force distribution control as configured in the second embodiment.

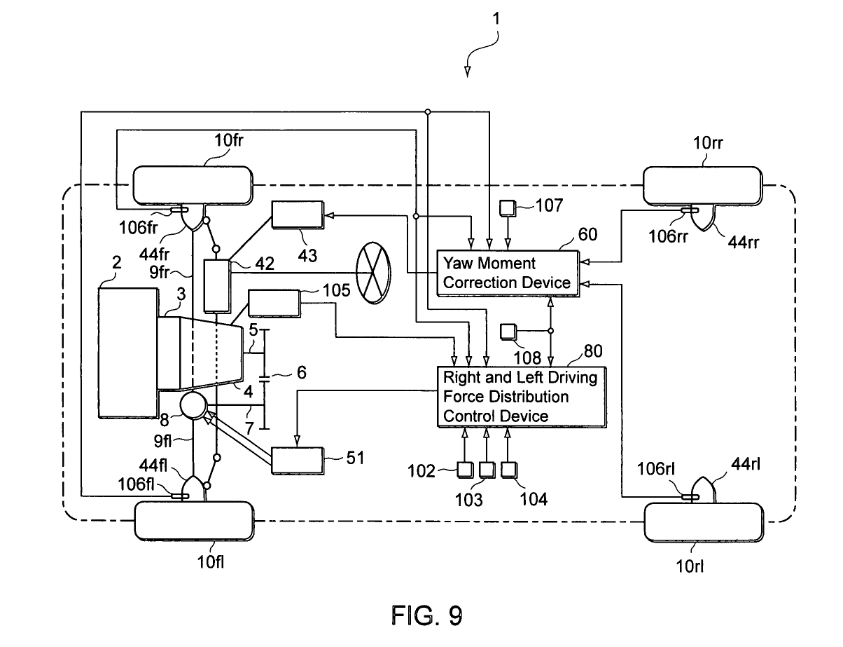

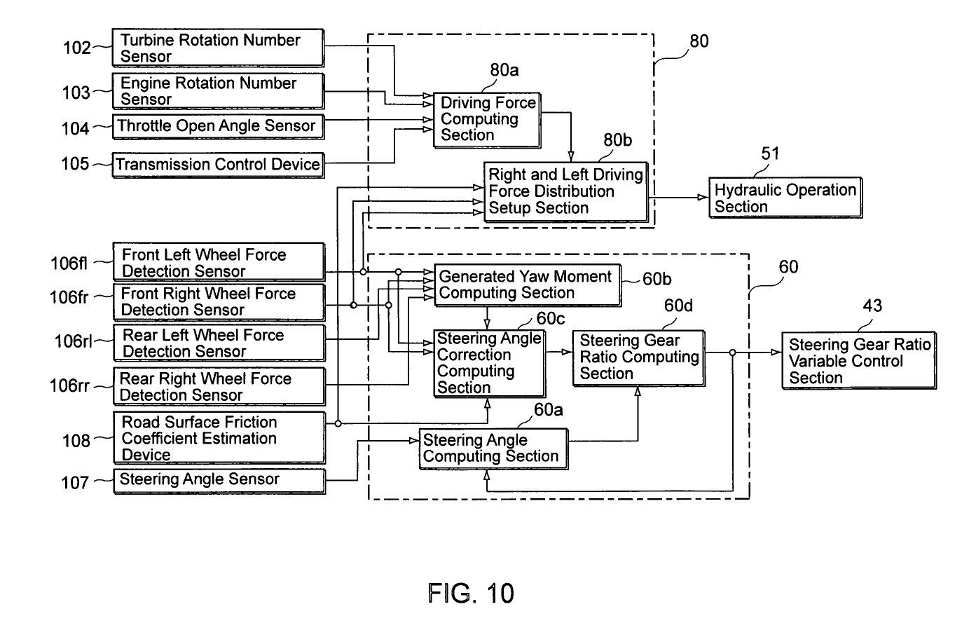

FIGS. 9 and 10 show a third embodiment according to the present invention. Specifically, FIG. 9 is a diagram showing a schematic structure of a vehicle provided with a vehicle behavior control device according to the third embodiment; and FIG. 10 is a functional block diagram of the yaw moment correction device and the vehicle behavior control device according to the third embodiment. The only difference among the first, second and third embodiments is the right and left driving force distribution control device as a vehicle driving force distribution control unit. Since the configuration of the other parts and their functional effects are the same among the three embodiments, the same reference numerals are used throughout for those parts, and the associated explanations are omitted below.

In FIGS. 9 and 10, the reference numeral 80 refers to the right and left driving force distribution control device, which is connected to the turbine rotation number sensor 102, the engine rotation number sensor 103, the throttle open angle sensor 104, the transmission control device 105, and the road surface friction coefficient estimation device 108. Inputs from these parts to the right and left driving force distribution control device 80 are the turbine rotation number Nt, the engine rotation number Ne, the throttle open angle θth, the transmission gear ratio rg, and the road surface friction coefficient estimated value μ, respectively. In addition, the right and left driving force distribution control device 80 is connected to the front wheel force detection sensors 106fl and 106fr. Inputs from these sensors to the right and left driving force distribution control device 80 are the lateral and vertical forces for the front left and front right wheels Ffly, Fflz, Ffry, and Ffrz, respectively. As shown in FIG. 10, the right and left driving force distribution control device 80 mainly comprises a driving force computing section 80a and a right and left driving force distribution setup section 80b.

Similar to the driving force computing section 50a in the first embodiment, the driving force computing section 80a in the third embodiment receives the turbine rotation number Nt, the engine rotation number Ne, the throttle open angle θth, and the transmission gear ratio rg from the turbine rotation number sensor 102, the engine rotation number sensor 103, the throttle open angle sensor 104, and the transmission control device 105, respectively. By using the above inputs and transmission characteristics, the engine driving force Fe is obtained as in Eq. (1). The result is then outputted to the right and left driving force distribution setup section 80b. In addition, the right and left driving force distribution setup section 80b receives the road surface friction coefficient estimated value p from the road surface friction coefficient estimation device 108, and the lateral and vertical forces Ffly, Fflz, Ffry, and Ffrz from the front wheel force detection sensors 106fl and 106fr. By using these inputs, the distribution ratio between the right and left forces, a, is determined as in Eq. (14) such that a friction circular utilization ratio becomes equal between the right and left wheels:
(a²·Fe²+Ffly²)^{1/2}/(μfl·Fflz)=((1−a)²·Fe²+Ffry²)^{1/2}/(μfr·Ffrz). (14)
A signal is then emitted to the hydraulic operation section 51 for distributing the engine driving force Fe based on the above distribution ratio between the right and left driving forces. The distinct notations of μfl are μfr are used in Eq. (14), enabling easy substitution of the road surface friction coefficient estimated value μ for each wheel. However, in the present third embodiment, these values are equal, i.e. μfl=μfr=μ.

As seen above, the same effect as that obtained in the first embodiment can be obtained by use of a different right and left driving force distribution control as configured in the third embodiment.

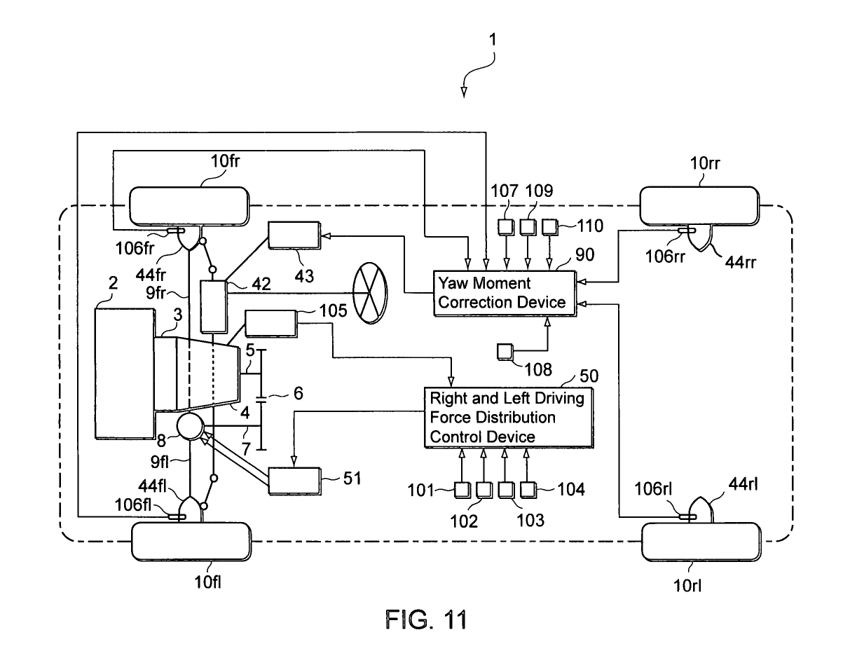

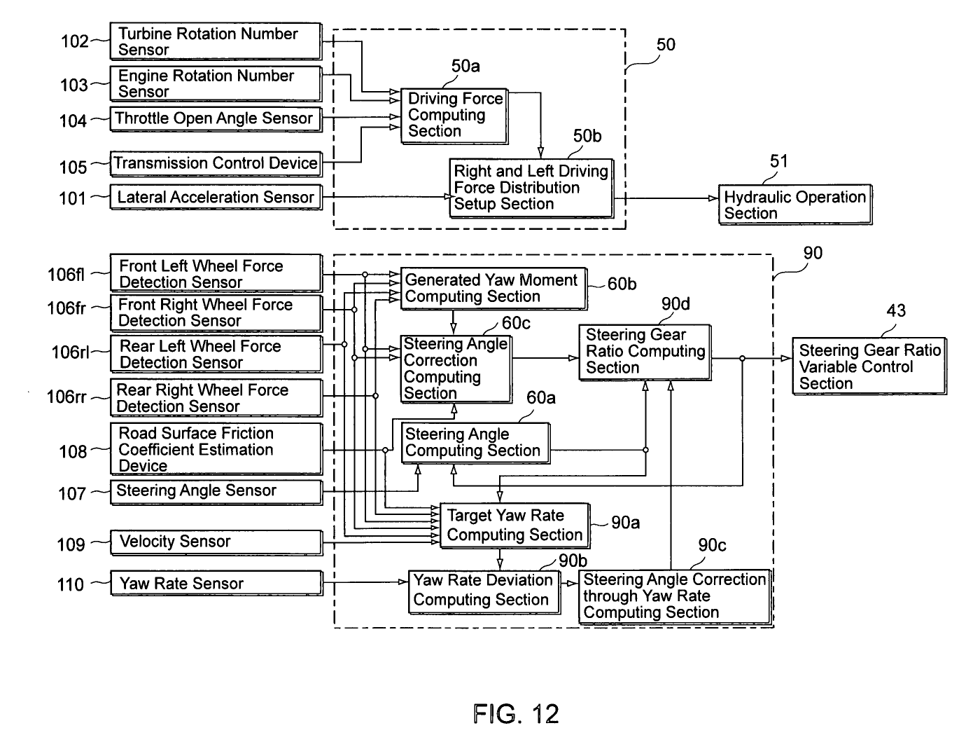

FIGS. 11 and 12 show a fourth embodiment according to the present invention. Specifically, FIG. 11 is a diagram showing a schematic structure of a vehicle provided with a vehicle behavior control device according to the fourth embodiment; and FIG. 12 is a functional block diagram of the yaw moment correction device and the vehicle behavior control device according to the fourth embodiment. The only difference between the first and fourth embodiments is the yaw moment correction device. Since the configuration of the other parts and their functional effects are the same between the first and fourth embodiments, the same reference numerals are used throughout for those parts, and the associated explanations are omitted below.

In FIGS. 11 and 12, the reference numeral 90 refers to the yaw moment correction device, which is connected to the force detection sensors 106fl, 106fr, 106rl, and 106rr. Inputs from these sensors to the yaw moment correction device 90 are the longitudinal, lateral, and vertical forces for the front left, front right, rear left and rear right wheels Fflx, Ffly, Fflz, Ffrx, Ffry, Ffrz,, Frlx, Frly, Frlz, Frrx, Frry, and Frrz, respectively.

The yaw moment correction device 90 is further connected to the steering angle sensor 107 and the road surface friction coefficient estimation device 108, as well as to a velocity sensor 109 and a yaw rate sensor 110. Inputs from these parts to the yaw moment correction device 90 are the steering angle θH and the road surface friction coefficient estimated value μ, as well as the velocity V and the actual yaw rate (dφ/dt)s, respectively. As shown in FIG. 12, the yaw moment correction device 90 mainly comprises the steering angle computing section 60a, the generated yaw moment computing section 60b, and the steering angle correction computing section 60c, as well as a target yaw rate computing section 90a, a yaw rate deviation computing section 90b, a steering angle correction through yaw rate computing section 90c, and a steering gear ratio computing section 90d.

The target yaw rate computing section 90a receives the longitudinal, lateral, and vertical forces for the front left, front right, rear left, and rear right wheels Fflx, Ffly, Fflz, Ffrx, Ffry, Ffrz,, Frlx, Frly, Frlz, Frrx, Frry, and Frrz from the force detection sensors 106fl, 106fr, 106rl, and 106rr, respectively, the steering angle θH from the steering angle sensor 107, the road surface friction coefficient estimated value μ from the road surface friction coefficient estimation device 108, and the velocity V from the velocity sensor 109. The target yaw rate (dφ/dt)t is obtained as in Eq. (15):
(dφ/dt)t=G(0)·(1/(1+Tr·s))·δf, (15)
where G(0) is a yaw rate stationary gain, Tr is a time constant, and s is a Laplace operator. The result is then outputted to the yaw rate deviation computing section 90b. In the above equations, the time constant Tr is obtained as in Eq. (16), and the yaw rate stationary gain G(0) is obtained as in Eq. (17):
Tr=(m·Lf·V)/(2·L·Kra) (16)
G(0)=(1/(1+Sf·V²))·(V/L), (17)
where L is a wheel base, Kra is the rear wheel cornering power as determined in Eq. (8), and sf is a stability factor which can be evaluated, for example, as follows:
sf=−m/(2·L²)·(Lf·Kfa−Lr·Kra)/(Kfa·Kra), (18)
where Kfa is the front wheel cornering power as determined in Eq. (7).

The yaw rate deviation computing section 90b receives the actual yaw rate (dφ/dt)s from the yaw rate sensor 110 and the target yaw rate (dφ/dt)t from the target yaw rate computing section 90a. By using these inputs, a yaw rate deviation Δ(dφ/dt) is obtained as in Eq. (19):
Δ(dφ/dt)=(dφ/dt)s−(dφ/dt)t, (19)
which is then outputted to the steering angle correction computing section 90c. Note here that the target yaw rate computing section 90a and the yaw rate deviation computing section 90b are together provided as a yaw rate deviation computing unit in the present embodiment.

The steering angle correction through yaw rate computing section 90c receives the yaw rate deviation Δ(dφ/dt) from the yaw rate deviation computing section 90b. A steering angle correction through yaw rate Δδfyaw is obtained as in Eq. (20):
Δδfyaw=kfyaw·Δ(dφ/dt), (20)
where kfyaw is a predetermined gain based on experiments or calculations. The result is then outputted to the steering gear ratio computing section 90d.

The steering gear ratio computing section 90d receives the front wheel steering angle δf from the steering angle computing section 60a, the front wheel steering angle correction Δδf from the steering angle correction computing section 60c, and the steering angle correction through yaw rate Δδfyaw from the steering angle correction through yaw rate computing section 90c. A new steering gear ratio srNew is computed by using the current steering gear ratio sr as in Eq. (21):
srNew=(δf/(δf+Δδf+Δδfyaw))·sr, (21)
which is then outputted to the steering gear ratio variable control section 43. Note here that the steering angle correction computing section 60c, the steering angle correction through yaw rate computing section 90c, and the steering gear ratio computing section 60d are together provided as a correcting unit in the present embodiment.

As seen above, according to the present fourth embodiment, a smooth and accurate control can be achieved via the added feedback of the target yaw rate (dφ/dt)t, in addition to the effects attained in the first embodiment.

It should be mentioned here that, although the right and left driving force distribution control device in the fourth embodiment is chosen to be the same as that in the first embodiment, it is possible to employ the one in either the second or third embodiment, or even any existing right and left driving force distribution control device.

Further, although a FF car is chosen as an example in all the embodiments, it is possible to apply the present invention to a FR (Front engine—Rear-wheel drive) car, a RR (Rear engine—Rear-wheel drive) car, or a four-wheel drive car, as long as the right and left distribution control is included. For the case of a four-wheel drive car, it is possible to apply the present invention to a front and rear driving force distribution control, additional to the right and left, and coordinate these controls. For the case of a four-wheel independent-motor driven car which is equipped with four independent motors to provide driving forces to respective wheels, the present invention can also be applied in such a way as to control the four motor driving forces based on the driving force distribution as computed through the present method. In this case, the unit where the driving forces to respective wheels are computed and controlled corresponds to a driving force distribution control unit.

Furthermore, although the right and left driving force distribution is computed based on the turbine rotation number Nt, the engine rotation number Ne, the throttle open angle θth, and the transmission gear ratio rg in all the embodiments, it is possible to obtain the engine driving force Fe by use of existing signals such as a fuel emission pulse.

Furthermore, although the right and left distribution of the engine driving force Fe is controlled in all the embodiments, it is possible to also control the distribution of the braking force to the right and left wheels.

Furthermore, although the yaw moment in all the embodiments is reduced by the yaw moment correction device which outputs a new steering gear ratio to the steering gear ratio variable control section 43, it is possible to reduce the yaw moment by directly inputting a new steering angle to a by-wire steering control device.

It is to be understood that the above-described embodiments are illustrative of only a few of the many possible specific embodiments which can represent applications of the principles of the invention. Numerous and varied other arrangements can be readily devised by those skilled in the art without departing from the spirit and scope of the invention.

What is claimed is:

1. A vehicle behavior control device comprising:
force detecting unit for detecting a tire force acting on each wheel of a vehicle;
yaw moment computing unit for computing a yaw moment of the vehicle based on the tire force acting on each wheel detected by the force detecting unit, the yaw moment being generated by a driving force transmitted to each wheel;
cornering power computing unit for computing a cornering power of each wheel based on the tire force acting on each wheel detected by the force detection unit; and
correcting unit for correcting the yaw moment to obtain a corrected yaw moment based on a moment of inertia of the vehicle and the cornering powers.

2. The vehicle behavior control device of claim 1, further comprising
driving force distribution control unit for controlling a driving force distribution,
wherein the yaw moment being generated by the driving force transmitted to each wheel is a yaw moment resulting from an action of the driving force distribution control unit.

3. The vehicle behavior control device of claim 2, wherein
the driving force distribution control unit controls the driving force distribution between a right and left wheels.

4. The vehicle behavior control device of claim 1, further comprising
steering angle correcting unit for correcting a steering angle,
wherein the correcting unit converts the corrected yaw moment to one of a steering angle and a steering gear ratio, which is then outputted to the steering angle correcting unit.

5. The vehicle behavior control device of claim 1, further comprising
yaw rate deviation computing unit for computing a target yaw rate based on driving conditions and obtaining a yaw rate deviation which is a difference between the target yaw rate and an actual yaw rate,
wherein the correcting unit corrects the yaw moment generated by the driving force to each wheel, based on the moment of inertia of the vehicle, the cornering powers, and the yaw rate deviation.
